(19) United States
(12) Patent Application Publication
(10) Pub. No.: US 2012/0262063 A1
(43) Pub. Date: Oct. 18, 2012

(54) FLOURESCENT LUMINAIRE DRIVE CIRCUIT

(75) Inventor: ANTHONY MANGIARACINA, MOBILE, AL (US)

(73) Assignee: ECO LIGHTING, LLC., MIAMI, FL (US)

(21) Appl. No.: 13/447,720

(22) Filed: Apr. 16, 2012

Related U.S. Application Data
(60) Provisional application No. 61/475,322, filed on Apr. 14, 2011.

(51) Int. Cl. H05B 41/36

(52) U.S. Cl. 315/107

(57) ABSTRACT

A circuit configuration for powering high-frequency fluorescent lamps with rapid start capability has input terminals connected to a ballast and output terminals connected to a fluorescent lamp. A transformer module has at least one primary winding that receives a power signal from the ballast and two or more secondary windings that are magnetically coupled to the primary winding. The secondary windings power the cathodes of the fluorescent lamp. The energizing signals are at a high frequency for powering high-frequency fluorescent lamps with rapid start capability. Tuning capacitors are used for tuning the high-frequency power signals. A control device, for instance for occupancy sensing and/or daylight harvesting may be connected into the circuit so as to further raise the efficiency of the luminaire by only energizing the lamp when it is useful.

### CROSS-REFERENCE TO RELATED APPLICATION

This application claims the benefit, under 35 U.S.C. §119(e), of provisional patent application No. 61/475,322, filed Apr. 14, 2011; the prior application is herewith incorporated by reference in its entirety.

### BACKGROUND OF THE INVENTION

### Field of the Invention

The invention pertains to fluorescent lighting systems and, more particularly, to systems for the easy conversion of fluorescent lights with magnetic ballasts to newer high-frequency systems and a further conversion to intelligent systems.

Fluorescent light bulbs are superior, in terms of energy efficiency, over incandescent light bulbs. The latter generate light by way of a resistance element that resists the electrical current to such an extent that the element starts to visibly glow. This generates heat, which is considered wasted energy in terms of the lighting efficiency. Fluorescent light bulbs use a gas to generate light. The gas is excited by the electrical power to generate light in the UV range. The UV light impinges on the coating of the bulb, which converts the UV light to visible light. Due to the fact that fluorescent light bulbs do not convert the electricity to heat, they are more efficient than incandescent light bulbs.

If fluorescent light bulbs were left without proper energy control, the gas would continue to gain in intensity until the light extinguishes. For that purpose, the fluorescent light bulb lighting systems use a so-called ballast. The ballast has two primary purposes, namely, to supply the initial energy (i.e., a jolt) to start the light generation—and to heat the cathode in some cases—and then to regulate the current flowing through the fixture at the proper level. Older systems use a magnetic ballast (they are called magnetic ballasts because they use an inductor as the reactive component) which leads to a power loss of approximately 5 to 25%. Newer systems use an electronic ballast with solid state circuitry. These are also called high-frequency ballasts, because they raise the mains frequency of 50 or 60 Hz to approximately 20 kHz or higher. Besides the fact that the low frequency flicker is eliminated by raising the frequency, the efficiency of the lamps is also improved by a factor of approximately 10% or more.

Fluorescent light bulbs come in different shapes and sizes. The most popular shapes are straight cylindrical tubes of different lengths and diameters. The diameter of the tube is referenced in the name of the fluorescent light bulb, namely, T12, T10, T8, and T5. The numerical indicator refers to one eighth (⅛) of an inch. The T5 tube has a diameter of ⅝ inches, the T8 tube has a diameter of 1 inch ( 8/8), the T10 tube has a diameter of 1 and ¼ inches ( 10/8), and the T12 tube has a diameter of 1.5 inchees ( 12/8). The fluorescent light bulbs, besides their physical dimensions, also come in a vast variety of power output and light temperature specifications. The light temperature ranges from below 3000 Kelvin to above 6500 Kelvin.

Standard T8 fixtures are typically equipped with instant start ballasts. That kind of ballast has no warm start. That means that the instant start ballast starts the lamps without heating the cathodes at all. Instant start ballasts are designed for a low frequency on/off circle between three and five (3-5) times per day. A high frequency on/off circle would cut the lifespan of the lamps to an considerable degree. Instant start ballasts are not suitable for environments using occupancy sensors or daylight harvesting sensors.

In the context of the straight cylindrical tubes to which the invention pertains, T5 lamps are slightly shorter than T8 lamps. That is, the T8, by way of example, is 1200 mm long while the corresponding-length T5 tube is 1148 mm long. They can only be used as replacements for the larger lamps by adding an adapter. Most luminaires are easily converted from T8 to T5 by changing a socket and the ballast.

Commonly assigned U.S. Pat. No. 7,936,129 B2 describes a converter assembly which connects between the terminals of the luminaire socket and the lamp terminals. The assembly is formed so as to bridge the spacing to the shorter tube as the T12 is replaced by a T8 lamp, for example. The magnetic ballast of the T12 lamp is bypassed, and the power signal is up-converted to the higher frequency so as to power the high-frequency lamp.

### BRIEF SUMMARY OF THE INVENTION

It is accordingly an object of the invention to provide an adapter assembly which overcomes the above-mentioned disadvantages of the heretofore-known devices and methods of this general type and which enables and simplifies the conversion of the prior fluorescent lighting systems with magnetic ballast start to newer, high-frequency systems with improved energy efficiency and a further conversion to systems for integration in more “intelligent” lighting systems.

With the foregoing and other objects in view there is provided, in accordance with the invention, a circuit configuration for powering a high-frequency fluorescent lamp with rapid start capability, the circuit comprising:

input terminals connected to an output of a ballast and receiving from the ballast a power signal;

a transformer module including at least one primary winding connected to receive the power signal from the ballast, a first secondary winding magnetically coupled to the primary winding for generating a secondary power signal for energizing a first cathode of the fluorescent lamp, and a second secondary winding magnetically coupled to the primary winding for generating a secondary power signal for energizing a second cathode of the fluorescent lamp;

wherein the first and second secondary windings are configured to generate the respective secondary power signals at a high frequency;

output terminals for connection of the cathodes of the high-frequency fluorescent lamp, the output terminals being connected to the first and second secondary windings through respective tuning capacitors for tuning the high-frequency power signals and carrying the high-frequency secondary power signals for energizing the fluorescent lamp.

In accordance with an added feature of the invention, a tuning capacitor is connected between the primary winding and a respective input terminal for connection to the ballast.

In accordance with an added feature of the invention the transformer module further comprises:

a third secondary winding magnetically coupled with the primary winding;

a diode and a capacitor connected for rectifying a current induced from the third secondary winding;

a normally closed relay switch disposed to be driven by the rectified current induced from the third secondary winding and connected in the circuit energizing the fluorescent lamp;

wherein significant cathode current flows to heat the cathodes of the fluorescent lamp when the relay switch is in its normally closed state, and the current is substantially reduced while the voltage across the lamp rises significantly to ignite the lamp with the relay switch in its open state.

In accordance with an added feature of the invention, there is provided a control device connected to control the relay switch. In a preferred embodiment of the invention, the control device includes an occupancy sensor configured to cause the lamp to be energized substantially only when one or more persons are present within an area being monitored by the occupancy sensor.

In accordance with a concomitant feature of the invention, there is provided a daylight sensor substantially overriding a control by the occupancy sensor when a sufficient amount of light is available within the area being lighted by the fluorescent lamp.

By way of definition, the term “low frequency” is understood to refer to a frequency below, say, 1000 Hz (<1 kHz) and the term “high frequency” is understood to refer to frequencies above 1000 Hz (>1 kHz). In general, high-frequency lamps to which this specification refers are operated at frequencies of 20 kHz and above.

The adapter according to the invention is designed to adapt the 1200 mm long T8 lamp to the 1148 mm long T5 lamp. Furthermore the adapter assembly includes an electronic circuit that converts the T8 high frequency instant start ballast (or even the T12 high frequency instant start/rapid start ballast) to T5 rapid start ballast or T5 programmed start ballast.

The T5 rapid start ballast applies voltage and heats the cathodes simultaneously. It provides superior lamp life and more cycle life, but uses slightly more energy as the cathodes in each end of the lamp continue to consume heating power as the lamp operates. A dimming circuit can be used, which maintains the heating current while allowing lamp current to be controlled.

The T5 programmed-start ballast is a more advanced version of rapid start. This ballast applies power to the filaments first, then after a short delay to allow the cathodes to preheat, applies voltage to the lamps to strike an arc. This ballast gives the best life and most starts from lamps, and so is preferred for applications with very frequent power cycling such as hallways and restrooms with occupancy sensor.

Our main retrofitting solutions with the adapter assemblies may be summarized as follows:
T8 electronic instant start ballast to T5 electronic rapid start ballast.
T8 electronic instant start ballast to T5 electronic programmed start with an integrated occupancy sensor.
T8 electronic instant start ballast to T5 electronic programmed start with an integrated daylight harvesting sensor.
T12 electronic ballast to T5 rapid start ballast.

A primary feature in the context of the invention is that the conversion is done electronically and it does not require any bridging or removal of the “old” ballast.

Specifically, we provide an adapter assembly that converts from high frequency instant start fluorescent luminaires (that starts the lamp without the aid of cathode heating) to a rapid start fluorescent light assembly that applies both voltage and heats the cathodes simultaneously or to a programmed-start fluorescent light assembly that applies heating currents to the lamp cathodes first. Then, after a pre-specified time delay, the starting voltage is applied to the lamp.

The adapter works with all fluorescent fixtures from 2 feet to 8 feet and includes circuit bridging devices if necessary.

In accordance with an added feature of the invention, we provide an adapter assembly that converts from high frequency instant start fluorescent luminaires (that starts the lamp without the aid of cathode heating) to a programmed-start fluorescent light assembly that applies heating currents to the lamp cathodes first and, after a pre-specified time delay, applies the starting voltage to lamp.

In accordance with an added feature of the invention, we provide an adapter assembly that converts from high frequency instant start fluorescent luminaires (that starts the lamp without the aid of cathode heating) to a high frequency instant start fluorescent luminaires for a T5 fluorescent lamp.

In accordance with an added feature of the invention, the high frequency fluorescent light fixture is a T12 fluorescent light fixture having T12 ballast, and the high-frequency programmed-start ballast is configured to energize a T5 fluorescent lamp.

In accordance with an added feature of the invention, the high frequency fluorescent light fixture is a T12 fluorescent light fixture having a T12 ballast, and said high-frequency programmed-start ballast is configured to energize a T5 fluorescent lamp with occupancy sensor. The occupancy sensor is integrated into the adapter.

In accordance with an added feature of the invention, the high frequency fluorescent light fixture is a T12 fluorescent light fixture having T12 ballast, and said high-frequency programmed-start ballast is configured to energize a T5 fluorescent lamp with daylight harvesting sensor. The daylight harvesting sensor is integrated into the adapter.

In accordance with an added feature of the invention, the high frequency fluorescent light fixture is a T8 fluorescent light fixture having aT8 ballast, and said high-frequency programmed-start ballast is configured to energize a T5 fluorescent lamp.

In accordance with an added feature of the invention, the high frequency fluorescent light fixture is a T8 fluorescent light fixture having a T8 ballast, and said high-frequency programmed-start ballast is configured to energize a T5 fluorescent lamp with occupancy sensor. The occupancy sensor is integrated into the adapter.

In accordance with an added feature of the invention, the high frequency fluorescent light fixture is a T8 fluorescent light fixture having a T8 ballast, and said high-frequency programmed-start ballast is configured to energize a T5 fluorescent lamp with daylight harvesting sensor. The daylight harvesting sensor is integrated into the adapter.

In accordance with an added feature of the invention, the light fixture is a low frequency fluorescent light fixture having a T12 ballast, and said ballast is configured to a high frequency programmed-start fluorescent light assembly which energizes a T5 fluorescent lamp.

In accordance with an added feature of the invention, the light fixture is a low frequency fluorescent light fixture having a T12 ballast, and said ballast is configured to a high frequency programmed-start fluorescent light assembly which energizes a T5 fluorescent lamp with occupancy sensor. The occupancy sensor is integrated into the adapter.

In accordance with an added feature of the invention, the light fixture is a low frequency fluorescent light fixture having a T12 ballast, and said ballast is configured to a high frequency programmed-start fluorescent light assembly which energizes a T5 fluorescent lamp with daylight harvesting sensor. The daylight harvesting sensor is integrated into the adapter.

In accordance with an added feature of the invention, the light fixture is a low frequency fluorescent light fixture having a T12 (it should be understood that T12, in the context, is equivalent to T10) ballast, and said ballast is configured to a high frequency programmed-start fluorescent light assembly which energizes a T5 fluorescent lamp.

In accordance with an added feature of the invention, the light fixture is a low frequency fluorescent light fixture having a T12 ballast, and said ballast is configured to a high frequency programmed-start fluorescent light assembly which energizes a T5 fluorescent lamp with occupancy sensor. The occupancy sensor is integrated into the adapter.

In accordance with an added feature of the invention, the light fixture is a low frequency fluorescent light fixture having a T12 ballast, and said ballast is configured to a high frequency programmed-start fluorescent light assembly which energizes a T5 fluorescent lamp with daylight harvesting sensor. The daylight harvesting sensor is integrated into the adapter.

In accordance with an added feature of the invention, the light fixture is a low frequency fluorescent light fixture having a T8 ballast, and said ballast is configured to a high frequency programmed-start fluorescent light assembly which energizes a T5 fluorescent lamp.

In accordance with an added feature of the invention, the light fixture is a low frequency fluorescent light fixture having a T8 ballast, and said ballast is configured to a high frequency programmed-start fluorescent light assembly which energizes a T5 fluorescent lamp with occupancy sensor. The occupancy sensor is integrated into the adapter.

In accordance with an added feature of the invention, the light fixture is a low frequency fluorescent light fixture having a T8 ballast, and said ballast is configured to a high frequency programmed-start fluorescent light assembly which energizes a T5 fluorescent lamp with daylight harvesting sensor. The daylight harvesting sensor is integrated into the adapter.

Other features which are considered as characteristic for the invention are set forth in the appended claims.

Although the invention is illustrated and described herein as embodied in an adapter assembly, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a schematic circuit diagram illustrating a simple rapid start circuit representing a first of three types of circuits

FIG. 2 is a schematic circuit diagram of a program start circuit; and

FIG. 3 is a schematic circuit diagram of a circuit with programmed start that further includes an occupancy control of the lighting system.

### DESCRIPTION OF A PREFERRED EMBODIMENT OF THE INVENTION

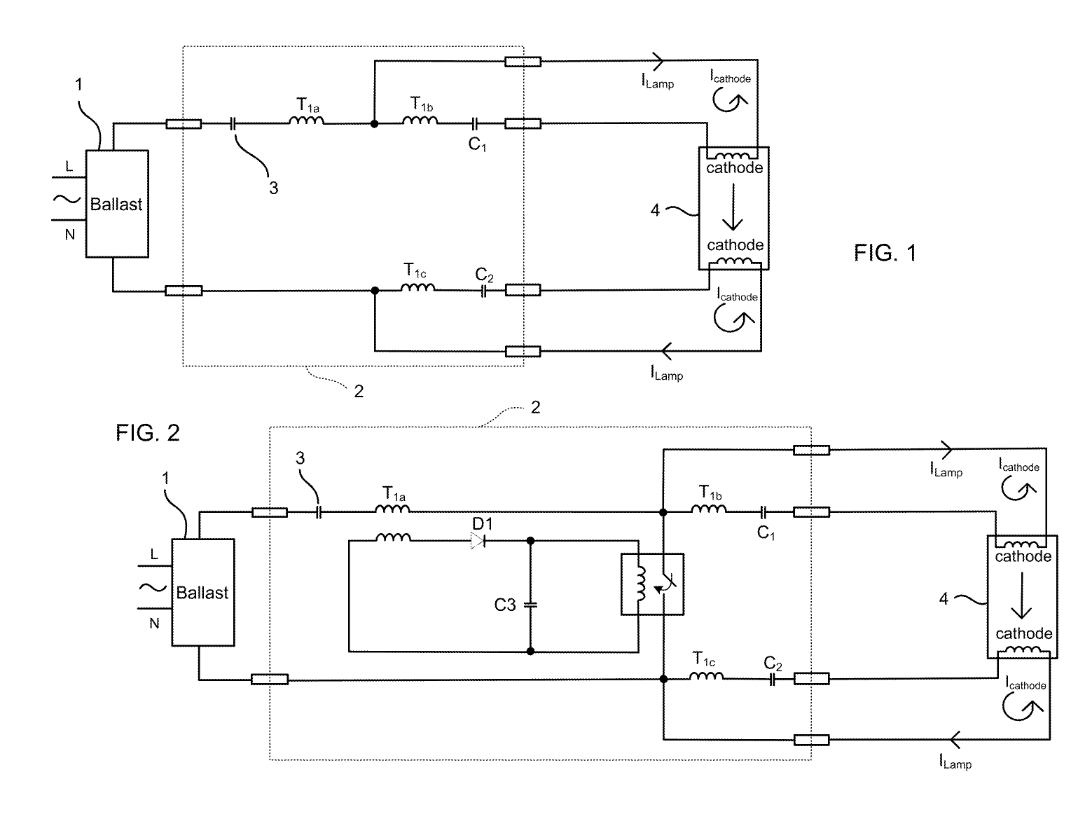

Referring now to the figures of the drawing in detail and first, particularly, to FIG. 1 thereof, there is seen a ballast 1 which is connected to a transformer module 2, which, in turn, is connected to a lamp 4. The ballast 1 receives an a.c. current on an input side and it is connected to a basic circuit on the output side. The basic circuit includes a transformer of the transformer module 2 (T1). The transformer T1 includes three windings T1a, T1b, T1c that are all magnetically coupled to each other. The winding T1a refers to a main primary winding that is electrically connected from the instant start ballast output to a rapid start lamp 4. A tuning capacitor is optionally connected between the instant start ballast and the T1a primary winding. A main lamp current labeled I_{Lamp} is the dominant current that illuminates the lamp 4. It is also referred to as an arc current. The lamp cathode currents labeled as I_{Cathode} are induced from the secondary windings T1b and T1c. Capacitors C1 and C2 are tuning capacitors to adjust the current to the lamp cathodes. Rapid start requires supplemental cathode heating to start and operate the lamp 4.

Referring now to FIG. 2, the transformer 2 (T1) includes four windings that are all magnetically coupled to each other. T1a is the main primary winding that is electrically connected from the instant start ballast output to the rapid start lamp 4. A tuning capacitor 3 is optionally connected between the instant start ballast 1 and the primary winding T1a. The main lamp current labeled as I_{Lamp} is the dominant current that illuminates the lamp 4, again also referred as the arc current. The lamp cathode currents are induced from the secondary windings T1b and T1c. Capacitors C1 and C2 are tuning capacitors that adjust the current to the lamp cathodes. Program Rapid start requires supplemental cathode heating before the lamp ignition state to reduce cathode sputtering.

The current induced from the secondary winding T1d is rectified by a diode D1 and a capacitor C3. The capacitor C3 potential will cause the relay to transition from the normally closed state to the normally open state. When the relay is in the normally closed state there is no voltage across the lamp with significant cathode current to heat the lamp cathodes. When the relay transitions from the normally closed state to the normally open state the lamp cathode current is significantly reduced and the lamp is exposed to the high ignition voltage that is exhibited from the instant start ballast.

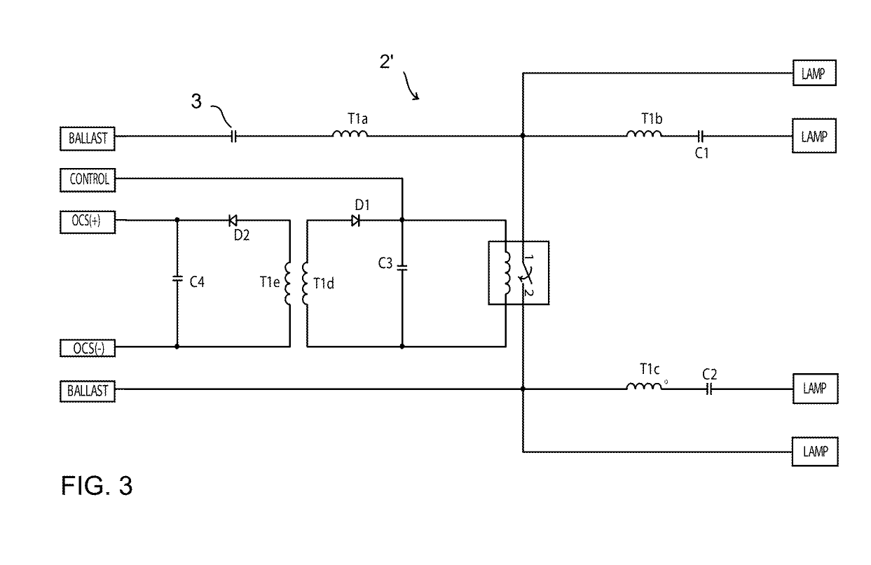

Referring now to FIG. 3, there is shown a modified transformer unit 2′. The potential of the secondary winding T1e is rectified by the diode D2 and the capacitor C4. This potential is used to power an occupancy sensor or a similar control device. The control device provides a potential through the control line to charge or discharge C3 that in turn controls the relay state. When the relay is in the normally closed state there is no voltage across the lamp with significant cathode current to heat the lamp cathodes. When the relay transitions from the normally closed state to the normally open state the lamp cathode current is significantly reduced and the lamp is exposed to the high ignition voltage that is output from the instant start ballast.

1. A circuit configuration for powering a high-frequency fluorescent lamp with rapid start capability, the circuit comprising:
input terminals connected to an output of a ballast and receiving from the ballast a power signal;
a transformer module including at least one primary winding connected to receive the power signal from the ballast, a first secondary winding magnetically coupled to said primary winding for generating a secondary power signal for energizing a first cathode of the fluorescent lamp, and a second secondary winding magnetically coupled to said primary winding for generating a secondary power signal for energizing a second cathode of the fluorescent lamp;
wherein said first and second secondary windings are configured to generate the respective secondary power signals at a high frequency;
output terminals for connection of the cathodes of the high-frequency fluorescent lamp, said output terminals being connected to said first and second secondary windings through respective tuning capacitors for tuning the high-frequency power signals and carrying the high-frequency secondary power signals for energizing the fluorescent lamp.

2. The circuit configuration according to claim 1, which further comprises a tuning capacitor connected between said primary winding and a respective said input terminal.

3. The circuit configuration according to claim 1, wherein said transformer module further comprises:
a third secondary winding magnetically coupled with said primary winding;
a diode and a capacitor connected for rectifying a current induced from said third secondary winding;
a normally closed relay switch disposed to be driven by the rectified current induced from said third secondary winding and connected in the circuit energizing the fluorescent lamp;
wherein significant cathode current flows to heat the cathodes of the fluorescent lamp when said relay switch is in its normally closed state, and the current is substantially reduced while the voltage across the lamp rises significantly to ignite the lamp with the relay switch in its open state.

4. The circuit configuration according to claim 3, which further comprises a control device connected to control said relay switch.

5. The circuit configuration according to claim 4, wherein said control device includes an occupancy sensor configured to cause the lamp to be energized substantially only when one or more persons are present within an area being monitored by the occupancy sensor.

6. The circuit configuration according to claim 4, wherein said control device includes a daylight sensor substantially overriding a control by the occupancy sensor when a sufficient amount of light is available within the area being lighted by the fluorescent lamp.
